(19) United States
(12) Patent Application Publication
(10) Pub. No.: US 2008/0313542 A1
(43) Pub. Date: Dec. 18, 2008

(54) SYSTEM AND METHOD FOR WITNESS TESTIMONY COLLECTION

(75) Inventors: James T. DeCrescenzo, Cherry Hill, NJ (US); Matthew J. McElvenny, Philadelphia, PA (US); Maureen C. Witkowski, West Chester, PA (US); William R. Craddock, Radnor, PA (US); Andrew Panciera, Philadelphia, PA (US); Brian N. Sack, Drexel Hill, PA (US); Walter E. Hicks, Jr., Rydal, PA (US); Carolina Roca-Smith, Philadelphia, PA (US)

Correspondence Address: PEPPER HAMILTON LLP, ONE MELLON CENTER, 50TH FLOOR, 500 GRANT STREET, PITTSBURGH, PA, 15219, US

(73) Assignee: TRIAL TECHNOLOGIES, INC., Philadelphia, PA (US)

(21) Appl. No.: 11/763,645

(22) Filed: Jun. 15, 2007

(51) Int. Cl. G06F 3/01; G06F 3/041

(52) U.S. Cl. 715/730; 715/764

(57) ABSTRACT

A witness testimony collection system may include a storage medium configured to store one or more documents. An interactive pen display device may be configured to transmit, in real time, digital ink markings on a document selected from the one or more documents. A high definition camera may be configured to transmit an image in real time. A mixer may be configured to receive input from the camera, the interactive pen display device and the storage device. The mixer may combine the input from the camera, the interactive pen display device and the storage device into a single output. A screen may be configured to receive input from the mixer. The screen may display an image of the digital ink markings on the selected document and the image from the camera on a single screen.

### BACKGROUND

A deposition is a well known legal proceeding. When a deposition is taken, a witness is typically asked to answer questions relating to a matter in dispute. Often a witness will be shown a document and asked to discuss its contents. The document may be crucial to the legal proceeding, such as a contract in a contract dispute or a picture in a car accident. Alternatively, a document may be used to explain how an event occurred. Often the witness may write or draw on the document to assist in the explanation. However, when the witness draws on the document, it is difficult for others in a deposition room to view the markings. Often, only the people closest to the witness are able to view the markings as they occur. Similar issues may arise in trial when a witness testifies in front of a judge or a jury.

### SUMMARY

In one embodiment, a witness testimony collection system may include a storage medium which may be configured to store one or more documents. An interactive pen display device may be configured to transmit, in real time, digital ink markings on a document selected from the one or more documents. A high definition camera may be configured to transmit an image in real time. A mixer may be configured to receive input from the camera, the interactive pen display device and the storage device. The mixer may combine the input from the camera, the interactive pen display device and the storage device into a single output. A screen may be configured to receive input from the mixer. The screen may display an image of the digital ink markings on the selected document and the image from the camera on a single screen. In one embodiment, the image transmitted by the camera may include an image of a witness. A recorder may be configured to store the output from the mixer.

In one embodiment, a method of taking a deposition may include selecting a document from one or more documents. A camera may be used to record a witness generating one or more markings to the selected document. The one or more markings on the selected document may be tracked. An image of the recorded witness and an image of the one or more markings on the selected document may be displayed on a single screen.

In one embodiment, prior to selecting a document, one or more documents may be scanned and stored. In an alternate embodiment, selecting from one or more documents may include selecting from the one or more documents that are stored. Displaying an image may include displaying a picture-in-picture image. A witness may be recorded generating one or more markings to the selected document using a high definition camera that has at least 1080 lines of resolution.

In one embodiment, the image of the recorded witness and the image of the one or more markings on the selected document may be stored. In one embodiment, the image of the recorded witness and the image of the one or more markings on the selected document may be displayed on a high definition plasma screen. The image of the recorded witness and the image of the one or more markings on the selected document may be converted into a high definition format. The image of the one or more markings on the selected document may be stored in a file readable to a mixer.

In an alternate embodiment, a method of taking a deposition may include scanning one or more documents, storing the one or more documents and selecting a document from the one or more documents. A camera may be used to record a witness generating one or more markings to the selected document using a camera. The one or more markings on the selected document may be tracked. An image of the recorded witness and an image of the one or more markings on the selected document may be displayed on a single screen.

In one embodiment, displaying an image may include displaying a picture-in-picture image. A witness may be recorded generating one or more markings to the selected document using a high definition camera. In one embodiment the image of the recorded witness and the image of the one or more markings on the selected document may be stored in a file. Displaying an image may include displaying the image of the recorded witness and the image of the one or more markings on the selected document on a high definition plasma screen. The image of the recorded witness and the image of the one or more markings on the selected document may be converted into a high definition format. In one embodiment, the image of the one or more markings on the selected document may be stored in a file readable to a mixer.

### BRIEF DESCRIPTION OF THE DRAWINGS

FIG. 1 depicts an exemplary witness testimony collection system in an embodiment.

FIG. 2 discloses a flowchart of an exemplary method of taking testimony from a witness in an embodiment.

FIG. 3 depicts an exemplary screen in an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

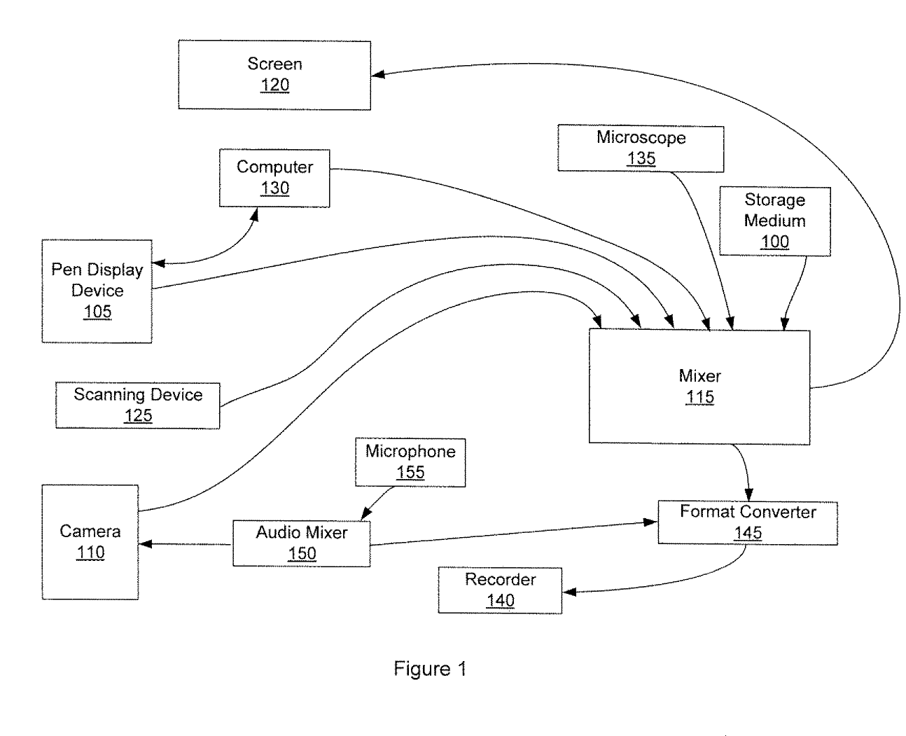

FIG. 1 depicts an exemplary witness testimony collection system in an embodiment. The system may include a storage medium 100. The storage medium 100 may be any repository of searchable data, such as a computer-readable memory or a carrier containing a database, a table, or other medium. A storage medium 100 may store one or more documents. A document is a writing or recording which contains information which may be stored or communicated.

The system may also include an interactive pen display device 105. For example, the interactive pen display device may be a device, such as the Smart Technologies Sympodium. The interactive pen display device may include an interactive screen, display control buttons, a connection panel and power. In one embodiment, the interactive screen may include a 15″ liquid crystal display (LCD) interactive screen. The screen may act as the input device and output device. In one embodiment, the interactive pen display device 105 may be connected to a computer 130 with an appropriate video card.

The interactive pen display device 105 may include a control pen. For example, the Smart Technologies Sympodium includes a tethered pen as the control pen. A document may be selected to be displayed on the interactive pen display device 105. The tethered pen may be used to control and manipulate items on a screen. In another embodiment, the control pen may create or remove digital ink. Markings may be generated by the control pen on a document and the markings may be displayed on the interactive pen display device 105. The interactive pen display device 105 may include a connection panel. The connection panel may include connectors such as one or more Universal Serial Bus (USB) receptacles, video inputs for a video cable to a projector or a monitor, and power receptacles for a power cable. In one embodiment, the images created by the control pen on the interactive pen display device 105 may be transmitted using image blending techniques. The image blending techniques may allow the markings along with the input document to be transmitted to a mixer 115.

Alternatively, the image of the document with the markings may be saved as a file. In one embodiment, the image may be stored in the storage medium 100, the pen display device 105 or an alternate storage facility. The image may be stored in a file format that is readable by the mixer 115. The stored image may be accessed at a later time to be displayed in the pen display device 105, displayed on the screen 120, or printed. In one embodiment, the printed image may be used as an exhibit during a trial.

The markings may be generated by a witness using the interactive pen display device 105. A witness is a person who has knowledge about a particular event at issue in a litigation matter. In one embodiment, a witness may be an eye-witness that heard or saw an event relevant to the issue in dispute. Alternatively, a witness may be an expert witness that has knowledge regarding an important issue in the dispute. A witness may testify in a variety of legal proceedings. A witness may be asked to discuss or verify a document displayed in the interactive pen display device 105.

The system may include a camera 110. A camera 110 is a device used to record an image. In one embodiment, a camera may include a video recorder. A camera 110 may be used to transmit an image in real time. In one embodiment, the camera 110 may display an image of a witness testifying. In one embodiment, the camera 110 is a digital camera which converts the analog information gathered by the camera and translates it into bytes of data. In one embodiment, the camera 110 is a high definition (HD) camera. In one embodiment, the camera has at least 1080 lines of resolution. The camera 110 may also include a liquid crystal display (LCD) screen. For example, a camera with 2000 lines of resolution may clearly transmit an image of both the witness marking on the document and the markings on the document. In one embodiment, the camera may connect to one or more external sources.

The camera 110 may be used to collect an image of the witness marking on the document using the pen control from the interactive pen display device 105. In one embodiment, the camera 110 is used to collect the image of the document on the interactive pen display device 105. In another embodiment, the camera may collect an image of both the witness marking the document and the document displayed on the interactive pen display device 105.

In one embodiment, the interactive pen display device 105 and the camera 110 may be connected to a mixer 115. A mixer enables mixing and switching of multi-format video signals. For example, a mixer 115 may be an Edirol Multi-Format Video Mixer V-440HD. A mixer 115 may convert and switch signals between high definition (HD), Red, Green, Blue (RGB) and standard (SD) formats. The mixer 115 may be used to output the signals to one or more multi-screen displays. In one embodiment, the mixer 115 may receive a video signal in one format and may output the video signal in a completely different format.

In one embodiment, the mixer can only read a fixed set of files containing text, graphics, images and video. For example, a mixer may be able to read file types such as, but not limited to, Adobe Portable Document Format (.pdf), Microsoft Word (.doc), Microsoft Excel (.xls), and Microsoft Windows Media (.wmv). However, images from specialized drawing programs such as, but not limited to, SilverScreen or AutoCAD, may not be readable by the mixer. The input to the mixer from the storage medium 100, pen display device 105, camera 110, scanning device 125, computer 130, and/or microscope 135 may be in a file format that is readable to the mixer. Storing all documents in a fixed set of format types may allow the documents to be displayed at a faster speed than prior art systems.

In one embodiment, multiple signals may be received into the mixer 115 and a single signal may be output to a screen 120. The screen 120 is capable of displaying a recording of an image. A screen 120 may include, but is not limited to, a flat panel display, a projector screen and a plasma screen. In one embodiment, the screen 120 may be a high definition screen with at least 1000 pixels to provide high quality resolution. In one embodiment, the screen 120 may be of a size so that everyone in a room may view the witness and the markings on the document. For example, the screen may be a Panasonic Digital High Definition Television or it may be a Canon Multimedia Projector.

Optionally, the system may include a scanning device 125. A scanning device 125 analyzes a document and converts the document into a digital image. Once a document is converted into a digital image by the scanning device 125, it may be transmitted to the mixer 115. The digital image created by the scanner may be in a file format readable by the mixer. The scanning device 125 provides the opportunity for documents to be added as needed during a deposition. In one embodiment, the scanner may be an Elmo device. Optionally, the system may also include a microscope 135 or a computer 130 which can create files and transmit the files to the mixer 115. In one embodiment, the computer 130 may transmit information directly to the mixer 115 if the information is in a file format that is readable to the mixer. In an alternate embodiment, a computer 130 may be contained within any of the individual devices included in the system, such as the storage medium 100 or the interactive display device 105.

In one embodiment, the video output from the mixer 115 may be transmitted to a recorder 140. In one embodiment, the recorder may be a digital high definition (HD) videocassette recorder. The recorder 140 may record and store high definition videos. For example, the recorder may be a Sony Digital HD Videocassette Recorder. In one embodiment, the recorder 140 may record and store high definition signals in an advanced video codec high definition (AVCHD) format. For example, a recorder may be a Sony VRD-MC5 AVCHD Burner. A recording in AVCHD format may be quickly displayed in high definition.

In one embodiment, the output from the mixer 115 may be placed in the input of a format converter 145. The output from the format converter 145 may be received by the recorder 140. The format converter 145 may be used to convert the format of the output of the mixer 140 to a high definition format. For example, a format converter may be an Edirol High Definition Format Converter, VC 200HD.

In one embodiment, an audio mixer 150 may send a signal from a microphone 155 to the format converter 145. The audio mixer 150 may receive input from one or more microphones 155. A microphone is a device that converts sound into an electric signal. For example, the microphone may be a Sony Electret Condenser Microphone. An audio mixer is an electronic device for changing, routing and combining the audio signals. In one embodiment, the volume may be adjusted. Alternatively, the tone may be changed or combined with other audio signals. For example, the audio mixer may be a Shure Six Channel Microphone Mixer. In one embodiment, the audio mixer 150 may send the signal to the camera 110.

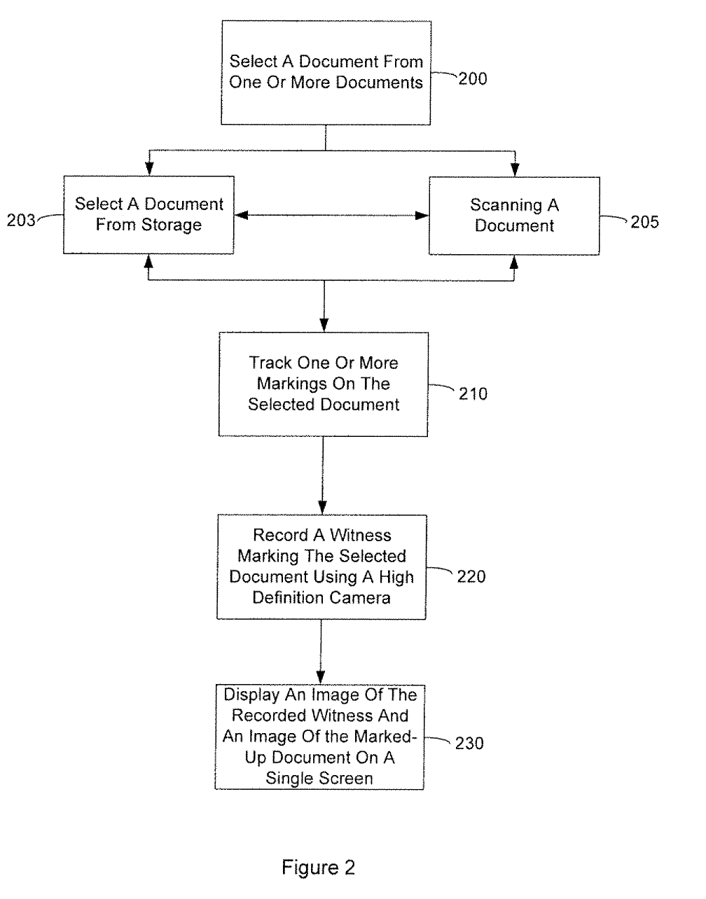

FIG. 2 discloses a flowchart of an exemplary method of taking testimony from a witness in an embodiment. In FIG. 2, a document may be selected from one or more documents 200. As defined above, a document may include, but is not limited to, a picture, an image, a deed, a blueprint or a contract. In an embodiment, one or more documents may be scanned 203. The one or more scanned documents may be stored 205. In an embodiment, using the scanning device, one or more documents may be scanned while a witness testifies. After the document is scanned, the document may be selected to be displayed via the interactive pen display device. Alternatively, the documents may be stored before a witness testifies. In an embodiment, a controller may select a document stored in a storage medium and an image of the document may be displayed on the interactive pen display device.

A witness may view the selected document on the interactive pen display device. The interactive pen display device may include an associated pen control. The pen control may be, but is not limited to, a digital ink pen. The witness may use the pen control to mark on the document shown on the interactive pen display device. One or more markings may be tracked on the selected document 210. The witness may generate one or more markings while testifying. For example, a witness may be examining a contract and may use the pen control to underline or circle important words and/or phrases. In another example, a witness may be reviewing an image of a device and the witness may use the pen control to explain how components of the device function. The markings generated by the witness using the control pen on the interactive pen display device may be transmitted, along with the image of the document, to the mixer.

As the witness marks on the document using the control pen, the witness may be recorded using a camera 220. In one embodiment, the camera may record the witness writing on the image of the selected document displayed on the interactive pen display device. In one embodiment, the camera may capture the information on the interactive pen display device. In one embodiment, the camera may capture both the witness marking on the display device as well as the image of the document and the markings on the document shown on the interactive pen display device.

The markings on the document along with the witness creating the markings may be displayed on a single screen 230. In one embodiment, a clean version of the document may also be displayed on the screen. In one embodiment, the display input may be received from the mixer. The mixer may receive input from the camera, the storage medium and the interactive pen display device. In one embodiment, the mixer may combine the input into a single recording to be displayed. In one embodiment, the recording may be saved and then displayed. In an alternate embodiment, the recording may displayed without being saved. In one embodiment, the recording is displayed in real time allowing the marks on the interactive pen display device to be displayed immediately after the marks are generated by the witness. In an alternate embodiment, the images are recorded and stored. The stored images may be displayed at a later time, such as during a trial.

In one embodiment, the display is a large screen. The screen may be used to provide people from a remote distance to simultaneously view the witness, the document, and the markings on the document, in real time. The combination of images in a single recording may allow the videos to be more interesting than in prior art systems.

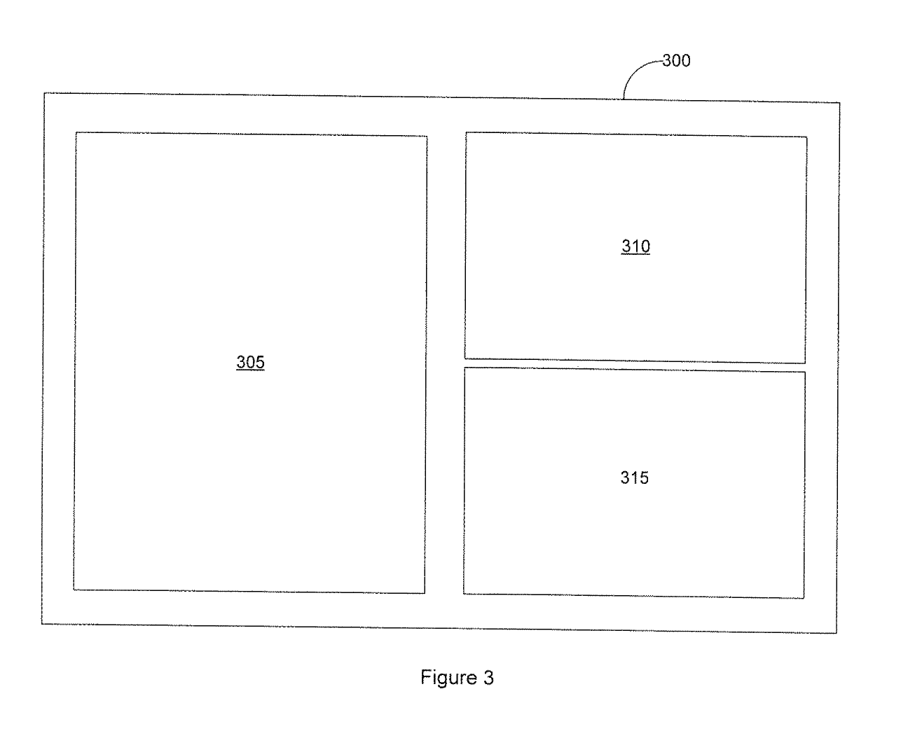

FIG. 3 depicts an exemplary embodiment of the images shown on the screen. The screen may display a single recording with images from the camera and the interactive pen display device. In another embodiment, the single screen may also display a single recording including images directly from a microscope, a computer, or a scanning device.

The images may be displayed on a large screen 300. The screen may be comprised of one or more windows 305, 310, 315. In one embodiment, the image of the document that the witness is examining may be displayed on a first window 305 on the screen. The document image displayed on the first window 305 may be the image shown on the interactive pen display device. The first window 305 may display the markings which were generated by the control pen. In addition, there may be a second window 310 in another area of the screen which displays the document in its original form with no markings from the witness.

The image from the camera of the witness testifying and marking the document may be shown in a third window 315 on the screen. In one embodiment the image may include both the witness and the document that the witness is marking. In one embodiment, the markings and the image of the document can be viewed in conjunction with the witness. Alternatively, the markings may only be shown in the first window 305 where the document is shown.

In one embodiment, the windows may be displayed in any area on the screen. The windows may be rotated so that the first window 305 displays the document being marked. Alternatively, the first window 305 may display the witness writing on the document. Additionally, the images displayed on the second window 310 and the third window 315 may be modified. In another embodiment, the shape and the size of the windows on the screen may be resized.

In an alternate embodiment, the screen may show a picture-in picture display. For example, the image of the witness from the camera may be inside the image of the document with the markings from the interactive pen display device. Regardless, the images may be combined into a single recording which may be displayed on the screen.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A witness testimony collection system comprising:
a storage medium configured to store one or more documents;
an interactive pen display device configured to transmit, in real lime, digital ink markings on a document selected from the one or more documents;
a high definition camera configured to transmit an image in real time;
a mixer configured to receive input from the camera, the interactive pen display device and the storage device, wherein the mixer combines the input from the camera, the interactive pen display device and the storage device into a single output; and
a screen configured to receive input from the mixer, wherein the screen displays an image of the digital ink markings on the selected document, and the image from the camera on a single screen.

2. The system of claim 1 wherein the image transmitted by the camera comprises an image of a witness.

3. The system of claim 1 further comprising:
a recorder configured to store the output from the mixer.

4. A method of taking a deposition, the method comprising:
selecting a document from one or more documents;
recording a witness generating one or more markings to the selected document using a camera;
tracking the one or more markings on the selected document; and
displaying an image of the recorded witness and an image of the one or more markings on the selected document on a single screen.

5. The method of claim 4 wherein prior to selecting a document from one or more documents comprises:
scanning the one or more documents; and
storing the one or more documents.

6. The method of claim 4 wherein the selecting from one or more documents comprises:
selecting from the one or more documents that are stored.

8. The method of claim 4 wherein the displaying an image comprises:
displaying a picture-in-picture image.

9. The method of claim 4 wherein recording a witness generating one or more markings to the selected document using a camera comprises using a high definition camera that has at least 1080 lines of resolution.

10. The method of claim 4 further comprising:
storing the image of the recorded witness and the image of the one or more markings on the selected document.

11. The method of claim 4 wherein the displaying an image comprises:
displaying the image of the recorded witness and the image of the one or more markings on the selected document on a high definition plasma screen.

12. The method of claim 4 further comprising:
converting the image of the recorded witness and the image of the one or more markings on the selected document into a high definition format.

13. The method of claim 4 further comprising:
storing the image of the one or more markings on the selected document in a file, wherein the file is readable to a mixer.

14. A method of taking a deposition, the method comprising:
scanning one or more documents;
storing the one or more documents;
selecting a document from the one or more documents;
recording a witness generating one or more markings to the selected document using a camera;
tracking the one or more markings on the selected document; and
displaying an image of the recorded witness and an image of the one or more markings on the selected document on a single screen.

15. The method of claim 14 wherein the displaying an image comprises:
displaying a picture-in-picture image.

16. The method of claim 14 wherein recording a witness generating one or more markings to the selected document using a camera comprises using a high definition camera.

17. The method of claim 14 further comprising:
storing the image of the recorded witness and the image of the one or more markings on the selected document in a file.

18. The method of claim 14 wherein the displaying an image comprises:
displaying the image of the recorded witness and the image of the one or more markings on the selected document on a high definition plasma screen.

19. The method of claim 14 further comprising:
converting the image of the recorded witness and the image of the one or more markings on the selected document into a high definition format.

20. The method of claim 14 further comprising:
storing the image of the one or more markings on the selected document in a file, wherein the file is readable to a mixer.
